(19) United States
(12) Patent Application Publication
(10) Pub. No.: US 2004/0105091 A1
(43) Pub. Date: Jun. 3, 2004

(54) Devices for measuring light from a source in situ

(76) Inventors: Nasir J. Zaidi, Valencia, CA (US); Kenneth Miller, Simi Valley, CA (US)

Correspondence Address: STRADLING YOCCO CARLSON & RAUTH, SUITE 1600, 660 NEWPORT CENTER DRIVE, P.O. BOX 7680, NEWPORT BEACH, CA, 92660, US

(21) Appl. No.: 10/648,938

(22) Filed: Aug. 26, 2003

Related U.S. Application Data
(60) Provisional application No. 60/406,233, filed on Aug. 26, 2002.

(51) Int. Cl. G01J 1/42

(52) U.S. Cl. 356/221

(57) ABSTRACT

A device for measuring light from a source includes a photometer and a collector. The photometer may include a detector, circuitry for processing output signals from the detector, and an output such as an LCD display. The collector engages with the photometer such that light from the source is incident on the detector and ambient light is prevented from entering. The collector may be configured to be releasably engageable with the photometer. A plurality of interchangeable collectors may be provided so that a single photometer is enabled to measure light from a plurality of sources. The collector may include a hood for engaging the source to block ambient light. The collector may also include optics disposed within the hood for directing light from the source onto the detector. The optics may include an optical diffuser disposed within the hood such that light from the source first passes through the diffuser to be incident on the detector. The optics may also include a reflective layer disposed on an inside of the hood for reflecting light within the hood. The measuring device may be utilized for measuring light from a variety of sources, such as sources that utilize LED arrays. Further, the measuring device may be configured to measure light from a source without having to remove the source from the installation site, such as traffic signals.

### CROSS REFERENCE TO RELATED APPLICATION

The present application claims priority under 35 U.S.C. § 119(e) on United States Provisional Application for Patent Serial No. 60/406,233 filed Aug. 26, 2002, and entitled “Calibrated, Portable Traffic Control Light Photometer,” the entire disclosure of which is incorporated herein by reference.

### BACKGROUND

Embodiments of the present invention relate to measuring light intensity and luminance. More particularly, embodiments of the invention relate to an apparatus and methodology for measuring the intensity of LED arrays such as those utilized in traffic signals.

LED arrays are replacing incandescent lamps in many applications. For example, flashlights, automotive lights and directional signals, and traffic signals now utilize LEDs. In contrast to incandescent lamps with discretely and instantaneously burn out, LEDs degrade gradually over time. As such, the intensity of the light emitted by an LED decreases over time. Accordingly, whereas it is easy to determine when an incandescent lamp needed replacing, it is difficult to determine when an LED or LED array has degraded to the point of needing to be replaced. This determination involves measuring the intensity of the light emitted by the LED.

Conventional measuring techniques involved taking the LED array to a dedicated lab to measure the intensity of the light. However, removing certain LED arrays from their installation site is not practical. For example, there is high cost and measurable inconvenience in removing an LED array from an installed and operating traffic signal.

### SUMMARY

According to one aspect of the invention, a device for measuring light from a source in situ includes a photometer and a collector. The photometer may include a detector, circuitry for processing output signals from the detector, and an output such as an LCD display. The collector engages with the photometer such that light from the source is incident on the detector. The collector may be configured to be releasably engageable with the photometer. In addition, a plurality of interchangeable collectors may be provided so that a single photometer is enabled to measure light from a plurality of sources.

According to another aspect of the invention, a collector may include a hood for engaging the source such that ambient light is prevented from entering the hood. The collector may also include optics disposed within the hood for directing light from the source onto the detector. For example, the optics may include an optical diffuser disposed within the hood such that light from the source first passes through the diffuser to be incident on the detector. In other embodiments, the optics may include a reflective layer disposed on an inside of the hood. The reflective layer reflects light within the hood.

Accordingly, the measuring device may be utilized for measuring light from a variety of sources, such as sources that utilize LED arrays. Further, the measuring device may be configured to measure light from a source without having to remove the source from the installation site. This feature is particularly useful in embodiments where the measuring device is configured to test the brightness of traffic signals.

Other features and advantages will become apparent to those skilled in the art from a consideration of the following detailed description taken in conjunction with the accompanying drawings.

### BRIEF DESCRIPTION OF THE DRAWINGS

FIG. 1 is a block diagram illustrating a measuring device;

FIG. 2 is schematically illustrates a measuring device engaged with a light source;

FIG. 3 is a fragmentary cross-sectional view of a hood of a collector;

FIG. 4 is a perspective view of a measuring device with a hood partially cut away;

FIG. 5 is a front view of a collector;

FIG. 6 is a cross-sectional view of an optical diffuser;

FIG. 7 schematically illustrates a measuring devices with a plurality of collectors;

FIG. 8 illustrates two traffic signals of different size;

FIG. 9 is a block diagram of circuitry of a photometer;

FIG. 10 is a fragmentary perspective view of a photometer;

FIG. 11 is a schematic view of circuitry of a photometer;

FIG. 12 is an exploded perspective view of a measuring device;

FIG. 13 is a side cut-away view of a measuring device;

FIG. 14 illustrates an optical diffuser with a diffusion pattern;

FIG. 15 is a cross-sectional view taken along line 15-15 of FIG. 14; and

FIG. 16 is a block diagram of a measuring device and a remote computer.

### DETAILED DESCRIPTION

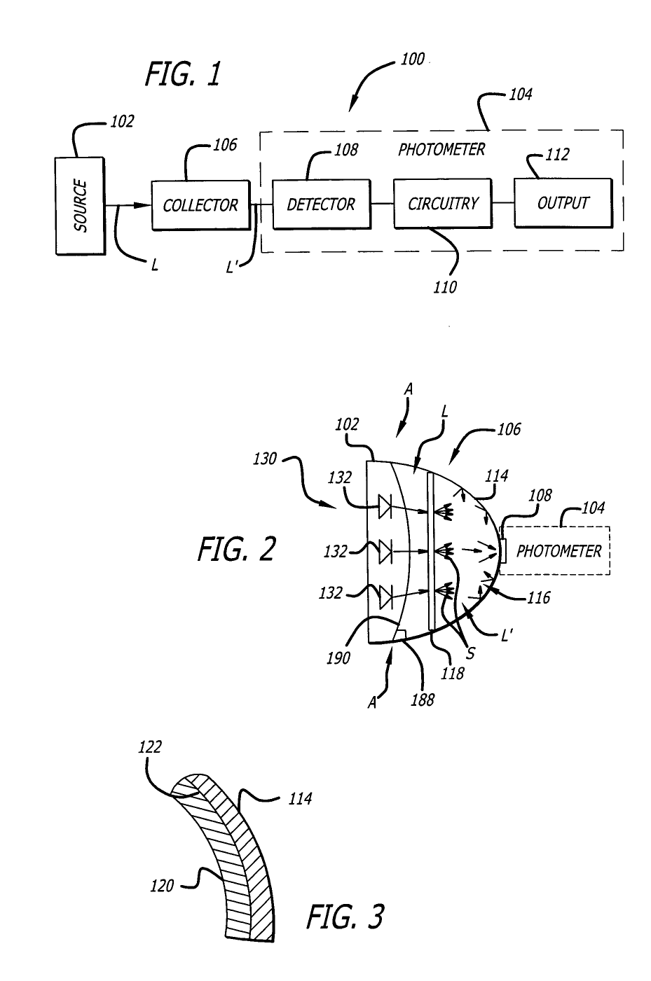

Referring more particularly to the drawings, a device 100 for measuring light L from a source 102 is illustrated in FIG. 1. As described in detail below, the measuring device 100 may be utilized for measuring light from a variety of sources, such as sources that utilize LED arrays. According to a number of embodiments, the measuring device 100 is configured to measure light from a source in situ, that is, at the installation site of the source. One embodiment in which this feature is useful is where the measuring device 100 is configured to test the brightness of traffic signals. Other embodiments will also be discussed below.

According to a number of embodiments, the device 100 includes a photometer 104 and a collector 106. The photometer 104 may include a detector 108, circuitry 110 for processing output signals from the detector 108, and an output 112 such as a display. With additional reference to FIG. 2, the collector 106 engages with the photometer 104 such that light L from the source 102 is incident on the detector 108, which incident light is indicated by L′. In many embodiments, the collector 106 is configured to be releasably engageable with the photometer 104, which will be discussed in more detail below.

As particularly shown in FIG. 2, the collector 106 may include a hood 116 for engaging the source 102 such that ambient light A is prevented from entering the hood 114 and, therefore, from being incident on the detector 108. In addition, the hood 116 may be configured so that all of the light L emanating from the source 102 enters the hood 116. Accordingly, only light L emanating from the source 102 is received within the hood 116. The collector 106 may also include optics 118 disposed within the hood 114 for directing light L from the source 102 onto the detector 108.

In a number of embodiments, the optics 116 may include an optical diffuser 118 disposed within the hood 114 such that light L from the source 102 first passes through the diffuser 118 to be incident on the detector 108. In other embodiments such as shown in FIG. 3, the optics 116 may also include a reflective layer or coating 120 disposed on an inside surface 122 of the hood 114. The reflective layer 120 reflects light within the hood 114 as shown by arrows R. Examples of the reflective coating 120 may include a layer of highly reflective white paint and a layer of mirror-like material.

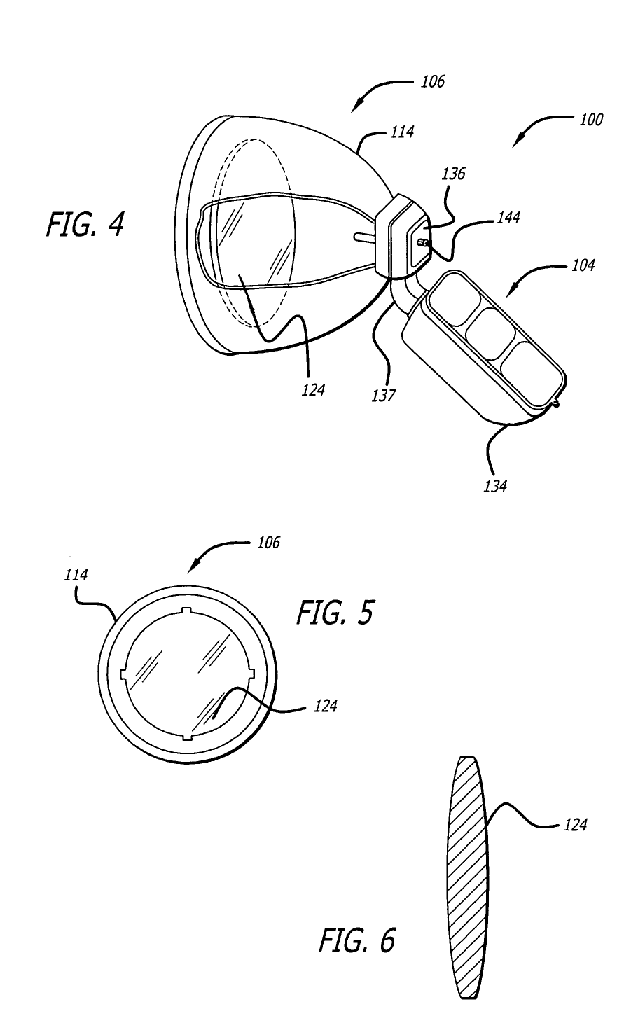

As shown in FIG. 2, the optical diffuser 118 is configured to scatter the light L from the source 102, which scattered light is indicated by S. For example, in some of the embodiments the optical diffuser 118 may include a plate 124 of translucent material, such as shown in FIGS. 4 and 5. As used herein, translucent indicates that a material is capable of transmitting light but causing sufficient diffusion to prevent perception of distinct images. In some of the embodiments, the plate 124 may be substantially planar as shown in the figures. In other embodiments, the plate 124 may be curvilinear or lens-like, such as shown in FIG. 6.

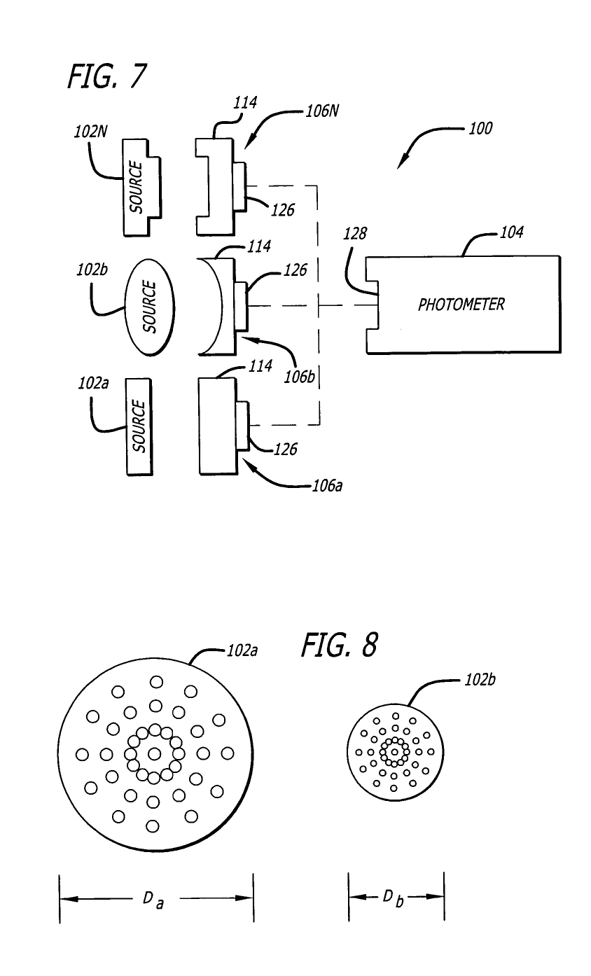

Referencing FIG. 7, the measuring device 100 may be configured to measure light from a plurality of light sources 102a, 102b, . . . 102N. As shown, each source 102 may have a predetermined configuration or a predetermined size that is different from the other sources. In these embodiments, the measuring device 100 may include a plurality of collectors 106a, 106b, . . . 106N each having a hood 114 that is configured to complement the configuration of a respective one of the sources 102. In addition, each collector 106 may include engagement structure 126 that is configured to releasably engage with complementary engagement structure 128 disposed on the photometer 104. Accordingly, in a number of embodiments, light from a plurality of sources 102 may be measured with a single photometer 104 and a plurality of interchangeable collectors 106.

In embodiments in which light from traffic signals is measured, the plurality of sources may include a first and a second traffic signal 102a and 102b each having a different configuration, for example, size as indicated by diameters D(a) and D(b), respectively. Accordingly, one of the collectors 106 may have a hood 114 that is configured to engage with the first traffic signal 102a, and one of the collectors 106 may have a hood 114 that is configured to engage with the second traffic signal 102b, both of which block ambient light being reaching the photometer 104.

With further reference to FIG. 1, many light sources 102 may include an array 130 of light-emitting diodes (LEDs) 132. In traffic-signal embodiments, the array 130 is configured so that each of the LEDs 132 emits light at a predetermined angle (as shown by arrows L) for purposes of maximizing visibility from different locations. For the purposes of this description, each of the LEDs 132 may be thought of as an individual light source, or a sub-source 132, in the array 130 transmitting light at an angle of emission. Accordingly, the optical diffuser 118 is configured to receive light L from the plurality of sub-sources 132 and transmit the light on to the photometer 104, regardless of the angle of emission of the light L from the sub-sources 132.

Referencing FIG. 4, in a number of embodiments the photometer 104 may be a portable hand-held device including a body 134 and a head 136, with the head being configured to receive the collector 106. The body 134 may house the circuitry 110 and the output 112 (see FIG. 1), and the head 136 may house the detector 108. The head and body 134 and 136 may be connected by a swivel connector 137.

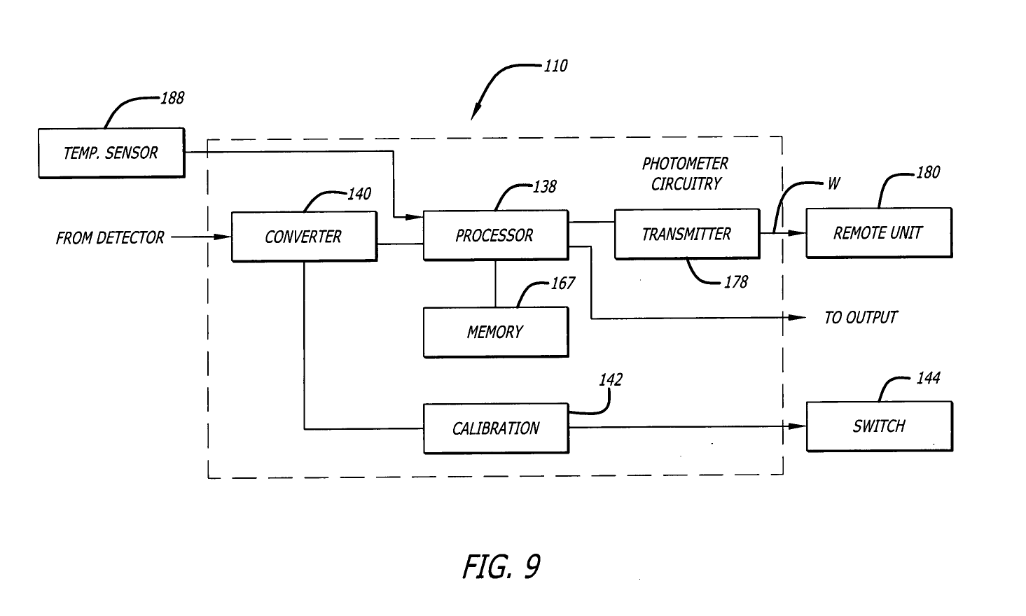

Light may be characterized by a number of parameters, including intensity and color. According to some of the embodiments, the detector 108 may provide an output that is indicative of at least one parameter of the light L, e.g., intensity. Referencing FIGS. 1 and 9, the circuitry 110 may include a processor 138 for processing the output of the detector 108. Based on this processing, the display 112 may provide an indication of the parameter of the light L responsive to the output of the detector. For example, the display 112 may output a numeric indication of the value of the intensity. Alternatively, the display 112 may output an indication on whether the intensity meets a predetermined threshold. In addition to a visual display such as an LCD, the output 112 may provide an audio output.

The photometer circuitry 110 may also include a converter 140. In some of the embodiments, the detector output may be an analog signal, with the converter 140 digitizing the signal for the processor 138.

In traffic-signal embodiments, the light source 102 may be characterized by a number of parameters, including color (e.g., red, yellow, green, and white), size (e.g., 8 inches or 12 inches in diameter), and shape (e.g., a stop light, a directional arrow, a pedestrian crossing signal, and so on). Accordingly, the photometer 104 may include a calibration circuit 142 for selectively providing a plurality of calibration signals. Each of the calibration signals may correspond to a particular type of light source. Depending upon the type of light source to be measured, a user may select via a switch 144 indicating the source to be measured, with the calibration circuit 142 responsively calibrating the converter 140 with parameters corresponding to the selected light source.

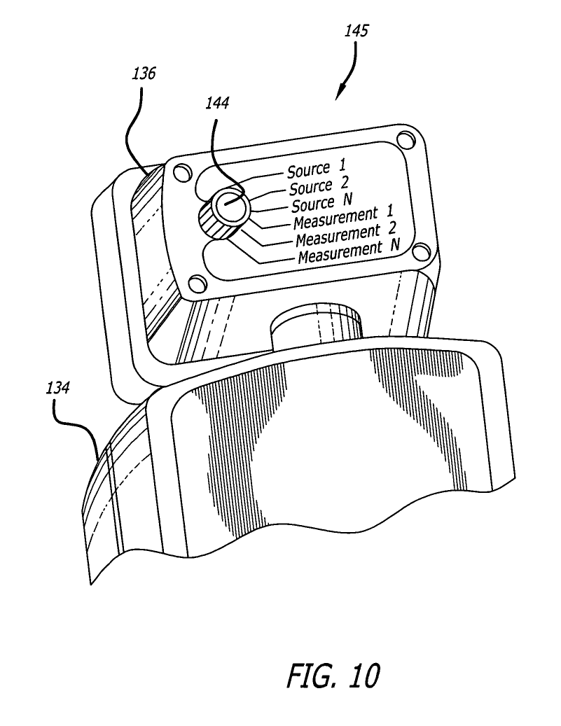

For example, as shown in FIG. 10, the switch 144 may be located on the head 136 of the photometer 104. The head 136 may include indicia 145 listing a plurality of measurable sources. In addition, the indicia 145 may include a plurality of measurement types, such as incident and reflected light measurements, including illuminance, luminance, irradiance, radiance, and so on.

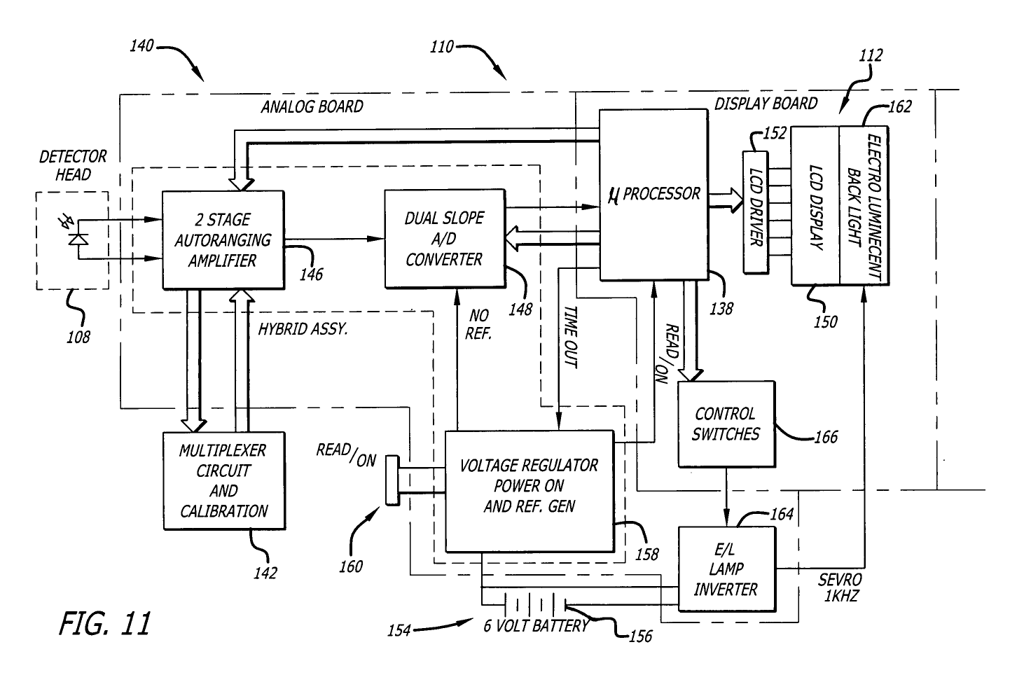

A number of embodiments of the measuring device 100 may include circuitry 110 as shown in FIG. 11. For example, the converter 140 may include an amplifier 146 connected to the detector 108 for amplifying the output signal therefrom. The converter 140 may include an analog-to-digital (A/D) converter 148 for converting the amplified signal to a digital signal for the processor 138. As mentioned, the output 112 may include a display, such as a liquid crystal display (LCD) 150 with a driver circuit 152 for receiving output signals from the processor 138.

A power supply 154 may include a battery 156 connected to a voltage regulator 158 for supplying power to the other components of the circuitry 110. An ON/OFF switch 160 may be provided for actuating the measurement of the light L. The power supply 154 may also power an electroluminescent backlight 162 for the LCD 150 via a lamp inverter 164.

Any number of control switches 166 may also be provided for actuating additional functions. For example, based on the signal from the detector 108, the processor 138 may be configured to estimate when the intensity of the light L from the source 102 falls below a threshold. As mentioned, the intensity of light emitted by LEDs degrades over time. Accordingly, based on known degradation characteristics, for example, stored in a memory 167 (see FIG. 9), the processor 138 may compare the measured value of intensity with the known characteristics to estimate when the intensity will fall below a certain level or threshold. The display 112 may then provide an indication of the same.

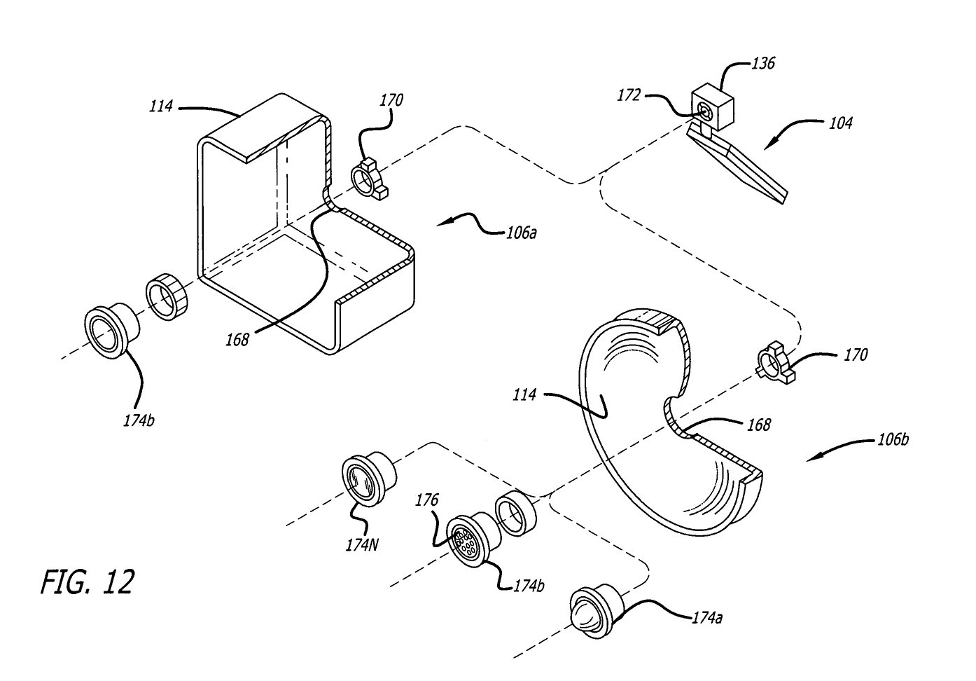

Referencing FIG. 12, the hood 114 of the collector 106 may include an opening 168 located at the interface with the head 136 of the photometer 104. The engagement structure previously mentioned may include a bayonet-type mount 170 for the hood 114 and a complementary mount 172 for the head 136.

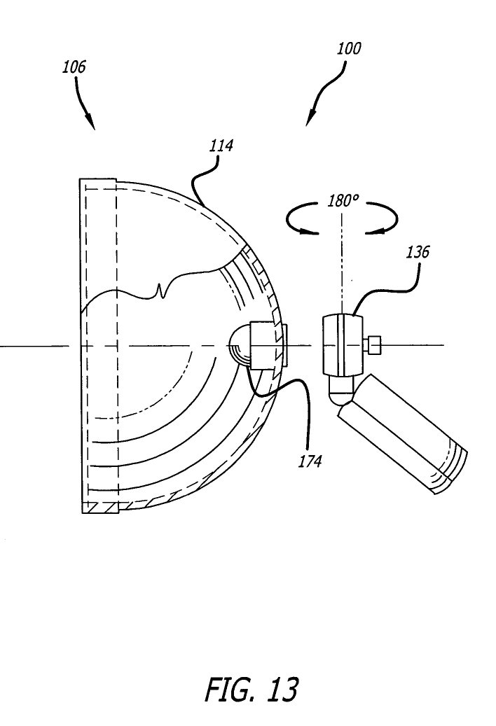

With additional reference to FIG. 13, the optics of the collector 106 may include a filter element 174 disposed at the opening 168 of the hood 114. In a number of embodiments, a plurality of interchangeable filter elements 174a, 174b, . . . 174N may be provided. The filter element 174 filters the light incident on the detector 108 to match the response function of the human eye. One of the filters, i.e., filter 174b, may include a plurality of honeycomb-type elements 176 configured to receive light at a predetermined angle.

According to a number of embodiments, the measuring device 100 may be configured to transmit data wireless to a remote location. More specifically, with further reference to FIG. 9, the photometer circuitry 110 may include a transmitter 178 in communication with the processor 138. Accordingly, responsive to the signal received from the detector 108, the transmitter 178 may wirelessly transmit a signal to a remote unit 180, which signal is indicated by W. In some of the embodiments, the calibration circuit 142 may receive calibration signals from the remote unit 180 for calibrating the converter 140 depending upon the parameters of the source 103.

The remote unit 180 may include an electronic information device capable of receiving data wirelessly such as a personal digital assistant (PDA), a palm-top or lap-top computer, a cellular device, or a desk-top computer with a wireless modem. Although the drawings indicate one-way data transmission, the circuitry 110 may be configured to receive data wireless as well; i.e., in certain embodiments, the transmitter 178 may be configured as a transceiver.

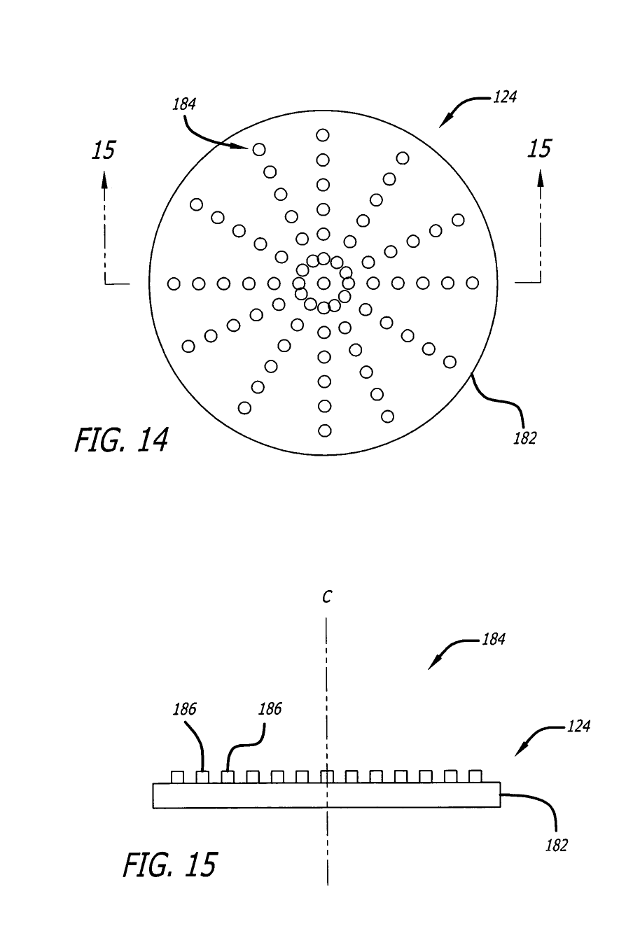

Referencing FIGS. 14 and 15, in certain embodiments the optical diffuser 124 may be configured to compensate for incongruities in the emittance pattern of the source 102. More specifically, depending upon the configuration of the source 102, a majority of the emitted light L (see FIG. 1) may be incident on the optical diffuser 124 at a region centered about an optical axis C. The amount of incident light L may then decrease as a function of radial distance outward from the central axis C.

To compensate for this decreasing concentration of incident light, the optical diffuser 124 may include a plate 182 with a diffusion pattern 184 disposed on one side thereof. The diffusion pattern 182 may be applied to the plate 182 so that the transmitted light L′ is substantially uniform spatially across the optical diffuser 124. As shown in the FIGS. 14 and 15, the diffusion pattern 184 may include a layer of dots 186 printed upon the plate 182, with the density of the dots being greater at the central region about the axis C than at the peripheral regions of the plate 182.

As mentioned, for certain sources, the light L is emitted at a predetermined angle. For example, because of the physical installation of traffic signals above an intersection (and often off center), the light L is emitted at a viewing angle that is about 5 degrees from the normal optical axis at least in one direction (i.e., downwardly). The light L may then be seen within a viewing envelop based on the predetermined viewing angle. It follows that the intensity of emitted light L is a function of position within the viewing envelop. Accordingly, traffic signals may then be thought of as having an emittance signature. In a number of embodiments, the diffusion pattern 184 may be disposed on the plate 182 to complement or to compensate for the emittance signature (or viewing envelope) of the source 102.

Referencing FIGS. 2 and 9, in still other embodiments the measuring device 100 may include a temperature sensor 188 in communication with the photometer circuitry 110. The temperature sensor 188 may be disposed on the collector 106 such that the temperature of the front surface of a lens 190 of the source 102 may be measured. The temperature sensor 188 is useful in embodiments in which the intensity of the emitted light L is a function of temperature, such as in certain LED array-source embodiments. The processor 138 may then utilize the temperature data from the sensor 188 for further processing.

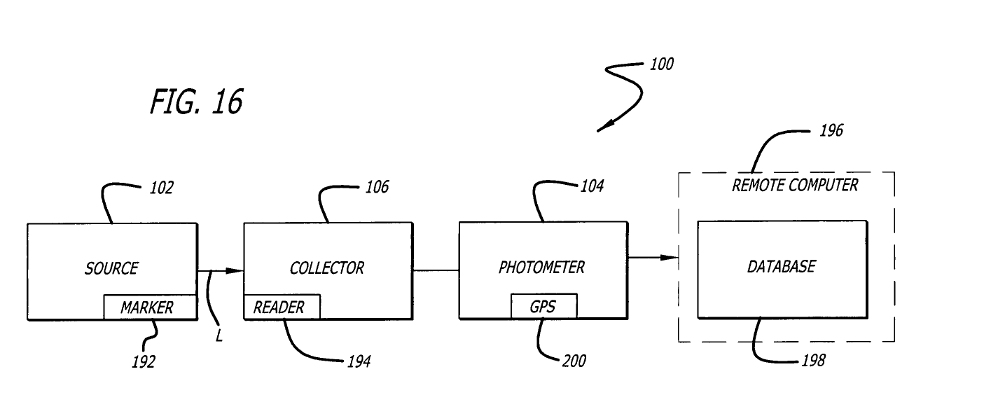

In addition to determining the type of source based on parameters as discussed above, in other embodiments the measuring device 100 may be configured to determine a particular individual source installed at a specific location. More particularly, with reference to FIG. 16, each source 102 to be measured may include an identifying marker 192 that includes information specific thereto, e.g., a barcode. Complementarily, the measuring device 100 may include a reader 194 for reading the data of the marker 192. The reader 194 may be disposed on the collector 194 as shown.

When the measurement of the light L is completed, data associated with the measurement and the source 102 may be sent to a remote computer 196 with a database 198. Based on the received data, the computer 196 may look up in the data base specific information on the source 102, for example, manufacturer name, warranty information, operating parameters, and so on.

Also shown in FIG. 16, the photometer 104 may include a global-positioning satellite (GPS) circuit 200 in some of the embodiments. In addition to measurement data and marker data, the photometer 104 may also transmit coordinate data generated by the GPS circuit 200 to the remote computer 196. The coordinate data along with measurement data from the photometer circuit 110 (see FIG. 1) may then be used to further identify particulars on the source 102.

Those skilled in the art will understand that the preceding embodiments of the present invention provide the foundation for numerous alternatives and modifications thereto. These other modifications are also within the scope of the present invention. Accordingly, the present invention is not limited to that precisely as shown and described in the present invention.

What is claimed is:

1. A device for measuring light from a source in situ, the device comprising:
a photometer including a detector; and
a collector for engaging with the photometer such that light from the source is incident on the detector, the collector including:
a hood for engaging the source such that ambient light is prevented from entering the hood; and
optics disposed within the hood for directing light from the source onto the detector.

2. The measuring device of claim 1 wherein the optics include an optical diffuser disposed within the hood such that light incident on the detector first passes through the optical diffuser.

3. The measuring device of claim 2 wherein the optical diffuser scatters the light from the source.

4. The measuring device of claim 2 wherein the optical diffuser includes a plate of translucent material.

5. The measuring device of claim 2 wherein the optical diffuser is substantially planar.

6. The measuring device of claim 2 wherein the optical diffuser is curvilinear.

7. The measuring device of claim 2 wherein the optical diffuser includes a plate and a diffusion pattern disposed on one side of the plated.

8. The measuring device of claim 1 wherein the optics include a reflective coating disposed on an inside surface of the hood.

9. The measuring device of claim 1 wherein the device measures intensity of light from a plurality of sources each having a configuration, at least one of the sources having a configuration that is different from that of the other sources, further comprising:
a plurality of collectors each having a hood that is configured to complement the configuration of one of the sources.

10. The measuring device of claim 9 wherein each of the collectors is engageable with the photometer.

11. The measuring device of claim 9 wherein the plurality of sources includes a first and a second traffic signal each having a different configuration;
one of the collectors having a hood that is configured to engage with the first traffic signal; and
one of the collectors having a hood that is configured to engage with the second traffic signal;

12. The measuring device of claim 1 wherein the detector provides an output indicative of at least one parameter of the light.

13. The measuring device of claim 12 wherein the output is indicative of intensity.

14. The measuring device of claim 12 wherein the photometer further includes a display for displaying an indication of the parameter of the light responsive to the output of the detector.

15. The measuring device of claim 1 wherein the photometer further includes a calibration circuit for selectively providing a plurality of calibration signals each corresponding to light from one of a plurality of sources.

16. The measuring device of claim 15 wherein the plurality of sources includes a traffic signal.

17. The measuring device of claim 16 wherein the traffic signal includes parameters of color, size, and shape.

18. The measuring device of claim 17 wherein the photometer further includes a display for displaying an indication of whether the intensity of the light of the traffic signal meets a threshold.

19. The measuring device of claim 17 wherein the photometer further includes a display for displaying an indication of the intensity of the light of the traffic signal.

20. The measuring device of claim 1 wherein the photometer further includes a circuit for estimating when the intensity of the light from the source falls below a threshold.

21. The measuring device of claim 1 wherein the photometer further includes a circuit for wirelessly transmitting data to a remote unit.

22. The measuring device of claim 21 further comprising the remote unit.

23. The measuring device of claim 1 further comprising a temperature sensor in communication with the photometer for measuring temperature of the source.

24. A method for measuring intensity of light from a source, the method comprising:
providing a measuring device including:
a photometer with a detector; and
a collector for engaging with the photometer and including:
a hood for engaging the source such that ambient light is prevented from entering the hood; and
optics disposed within the hood for directing light from the source onto the detector;
positioning the hood on the source; and
actuating the photometer.

25. The method of claim 24 wherein the collector is releasably engageable with the photometer, the method further comprising removing the collector from the photometer.

26. The method of claim 24 further comprising:
providing a second collector; and
replacing the collector engaged with the photometer with the second collector.

27. The method of claim 24 wherein there are a plurality of sources each having a different configuration, the method further comprising:
providing a plurality of collectors each including a hood that is configured to engage with a respective one of the sources so that ambient light is prevented from entering the hood.

28. The method of claim 27 further comprising:
selecting the collector that corresponds to the source to be measured; and
engaging the selected collector with the photometer.

29. The method of claim 27 wherein each of the sources emits light with a respective set of parameters, the method further comprising:
calibrating the photometer to be responsive to the light from the source being measured.

30. The method of claim 24 wherein the source is a traffic signal and the positioning step comprises:
positioning the hood on the traffic signal so that light emanating therefrom enters the hood.

31. A method for measuring intensity of light from a source, the method comprising:
receiving only light from the source;
diffusing the received light; and
detecting the diffused light.

32. The method of claim 31 further comprising generating a signal indicative of the detected light.

33. The method of claim 32 further comprising processing the signal.

34. The method of claim 33 further comprising generating an output responsive to the processed signal.

35. The method of claim 33 wherein the output is indicative of a parameter of the received light.

36. The method of claim 33 wherein the processing step determines intensity of the received light.

37. The method of claim 36 wherein the intensity of the light from the source degrades over time, the method further comprising estimating when the intensity will fall below a threshold.

38. The method of claim 31 wherein there are a plurality of sources each emitting light with a respective set of parameters, the method further comprising:
generating a signal indicative of at least one parameter of the received light.

39. The method of claim 38 wherein the signal is generated by a converter circuit, the method further comprising:
calibrating the converter circuit to be responsive to the light from the source being measured.

40. A device for measuring intensity of light from a plurality of traffic signals, each of the traffic signals having a respective configuration and including an LED array, the device measuring intensity without having the LED array removed from the traffic signal being measured, the device comprising:
a photometer including:
a detector for generating a signal indicative of the intensity of the light from the traffic signal;
circuitry connected for processing the signal from the detector; and
an output for displaying a signal responsive to the processed signal; and
a plurality of collectors each being releasably engageable with the photometer, each of the collectors including:
a hood having a configuration for engaging with a respective one of the traffic signals such that ambient light is prevented from entering the hood and all of the light emitted by the LED array enters the hood; and
optics disposed within the hood for directing light from the LED array of the traffic signal being measured onto the detector, the optics including:
a translucent optical diffuser disposed within the hood such that light incident on the detector first passes through the optical diffuser; and
a reflective layer disposed on an inside surface of the hood for reflecting light incident thereon.

41. The measuring device of claim 40 wherein the light emitted by each of the traffic signals has a respective set of parameters;
the circuitry for generating a signal indicative of at least one of parameters of the light from the traffic signal being measured.

42. The measuring device of claim 40 wherein the circuitry of the photometer includes:
a converter circuit connected to the detector for converting an analog signal from the detector to a digital signal for further processing; and
a calibration circuit for selectively providing a plurality of calibration signals to the converter circuit so that the converter circuit is responsive to light from the traffic signal being measured.

43. The measuring device of claim 40 wherein the circuitry of the photometer determines when the intensity of the light from the traffic signal being measured will fall below a threshold.
